(19) United States
(12) Patent Application Publication
(10) Pub. No.: US 2010/0217686 A1
(43) Pub. Date: Aug. 26, 2010

(54) SYSTEM FOR MANAGING COMMUNICATION BETWEEN A REAL ESTATE AGENT AND CLIENTS

(75) Inventors: Jeremy S. Craig, Anaheim, CA (US); William N. Olson, Foothill Ranch, CA (US); Amir Segal, Fullerton, CA (US)

Correspondence Address: KNOBBE MARTENS OLSON & BEAR LLP, 2040 MAIN STREET, FOURTEENTH FLOOR, IRVINE, CA, 92614, US

(73) Assignee: Superlative, Inc., Irvine, CA (US)

(21) Appl. No.: 12/639,824

(22) Filed: Dec. 16, 2009

Related U.S. Application Data
(63) Continuation of application No. 11/120,159, filed on May 2, 2005, now abandoned.
(60) Provisional application No. 60/568,014, filed on May 3, 2004.

(51) Int. Cl. G06Q 50/00; G06Q 30/00; G06Q 40/00; G06F 15/16; G06F 17/30; G06F 3/01

(52) U.S. Cl. 705/27; 709/206; 707/769; 715/760; 707/E17.014

(57) ABSTRACT

An Internet-based system for managing communication between a real estate agent and one or more clients is described. The system allows the real estate agent to provide MLS search results to the clients and the clients can indicate a level of interest for each property. The system facilitates easy two-way communication between the agent and the clients and keeps track of such communication so that the agent and the clients have a ready record of the properties that have been considered and the clients' level of interest in each property. For the agent, the system automates searching and information by client so that the agent can easily keep track of the type of property desired by each client and the properties considered by each client. For each of the clients, the system creates a personalized website that the client can visit at any time to view the new properties located by the agent and to review the properties already considered. Using conventional webpage user interface elements, the clients can indicate a level of interest for each property, thereby saving time for the agent and the client.

### REFERENCE TO RELATED APPLICATION

This application is a continuation of application Ser. No. 11/120,159, filed May 2, 2005, titled “SYSTEM FOR MANAGING COMMUNICATION BETWEEN A REAL ESTATE AGENT AND CLIENTS” which claims priority benefit of U.S. Provisional Application No. 60/568,014, filed May 3, 2004, titled “SYSTEM FOR MANAGING COMMUNICATION BETWEEN A REAL ESTATE AGENT AND CLIENTS,” the entire contents of which is hereby incorporated by reference.

### BACKGROUND

1. Field of the Invention

The invention relates to an Internet-based system for managing communication between a real-estate agent and one or more clients by creating a custom webpage for each client that list properties and the clients' interest in the properties.

2. Description of the Related Art

When working with a real estate agent to purchase a property, a client (potential buyer) typically views many properties. The agent runs a computer-based search on a property listing service (such as, for example, an MLS service) to find properties that fit the price, location, and other criteria selected by the client. Historically, the agent would print a list of properties and show the list to the client who would then select the properties to visit. Recently, agents have begun to send search results to the client through email. The client can view the email, select the desired properties, and then contact the agent either by telephone or email to view the selected properties. This method is disorganized and cumbersome for both the client and the agent. The agent is typically working with many clients, and it is difficult for the agent to keep track of which properties a client has been shown and the client's interest in those properties. The client typically looks at dozens of properties, and usually looses track of the various properties under consideration.

### SUMMARY

The present invention solves these and other problems by providing an Internet-based system whereby a real estate agent provides MLS search results to a client and the client can indicate a level of interest for each property. The system facilitates two-way communication between the agent and the client and keeps track of such communication such that the agent and the client have a ready record of the properties that have been considered by the client and the client's level of interest in each property. In one embodiment, for each client, the system allows the agent to specify an MLS search pattern that fits the type of property desired by the client. For the agent, the system organizes the information by client, so that the agent can easily keep track of the type of property desired by each client and the properties considered by each client. For the client, the system creates a personalized website that the client can visit at any time to view the new properties located by the agent and to review the properties already considered. The client can indicate a level of interest for each property, thereby saving time for the agent and the client.

In one embodiment, the agent and/or client selects a search profile for each client using one or more MLS search criteria, such as, for example, price, price range, county, area, address, address range, city, zip code, number of bedrooms, number of baths, builder, view, tract, model, year built, type of property, zoning, assessments, flood zone, parking, garage, car port, office-den, yard, yard size, lot size, master suite, retreat, RV space, security system, dining room, dressing area, walk-in closet, patio, patio size, solar, eating area, air conditioning, heating, spa, pool roof type, sprinkler system, timer, family room, separate family room, appliance hookups, appliances, 220 volt service, number of stories, TV, living room, entryway, laundry room, dryer, water softener, termite history, bonus room, wet bar, cable TV hookup, intercom, water service, sewer service, etc. Search criteria can also include financial information, such as, for example, loan points, possession, terms, loan type, first mortgage amount, second mortgage amount, interest rate, land fee/lease, land lease, when lease expires, renew ability of lease, association fees, etc. Once the search is constructed, the system can automatically run the search on a regular basis to identify new properties for the client. In one embodiment, search results are automatically entered into the client's custom webpage, and an email is sent to the client describing the properties identified in the search.

The client can then log onto the custom webpage and rate the properties. In one embodiment, the client specifies a level of interest (e.g., very interested, interested, somewhat interested, not interested, etc.) for each property. Since the process of running the search and sending the results to the client is automated, the agent is relieved of the burden of updating the search of each of the agent's clients. In one embodiment, the agent is notified (e.g., by email) that the search has been updated, and new results have been sent to the client. The management system also logs search activity and communications activity related to forwarding search results to the client on a communication summary panel as part of the custom webpage. If the agent ignores the notice, or does not receive a notice the agent can simply review the communication summary panel.

In one embodiment, the system maintains a record of communications between the client and the agent. In one embodiment, the communications can be sorted and/or filtered according to specific properties (e.g., specific MLS listings or property types).

### BRIEF DESCRIPTION OF THE DRAWINGS

FIG. 1 (consisting of FIGS. 1A and 1B) is a screen capture from a webpage showing the interface between the agent and the client.

FIG. 2 (consisting of FIGS. 2A, 2B, and 2C) is a screen capture from a webpage that allows an agent to construct an MLS search for the client.

FIG. 3 (consisting of FIGS. 3A and 3B) is a screen capture from a webpage that allows an agent to enter data for defining a prospect (client) for the management system.

FIG. 4 shows a client list page that provides summary information about the agent's clients.

### DETAILED DESCRIPTION

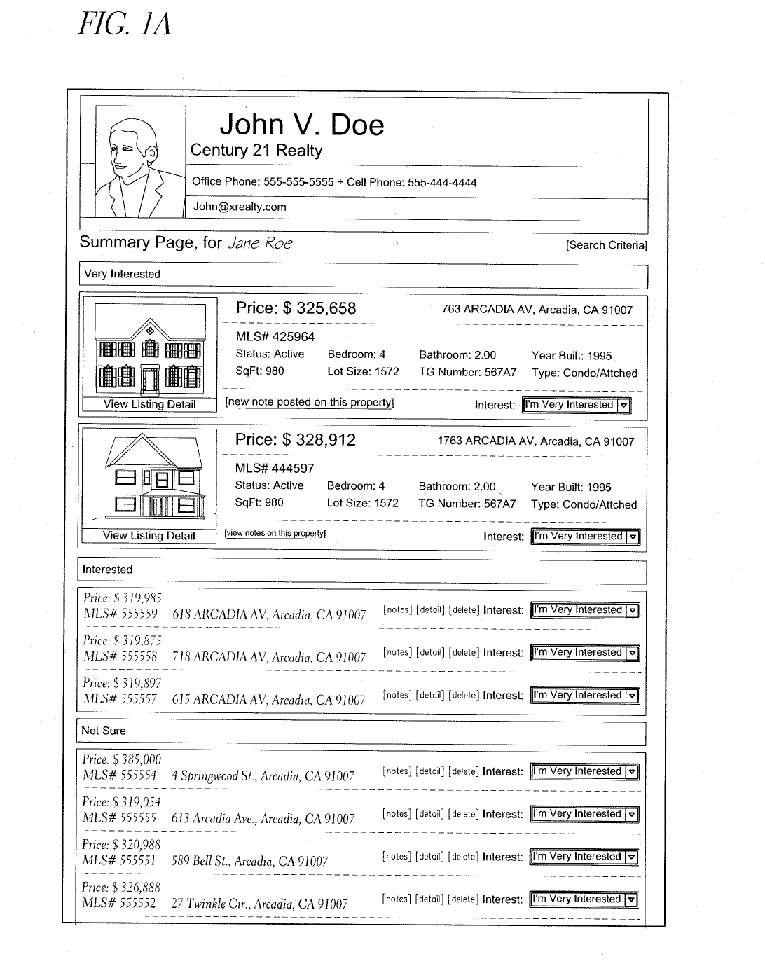

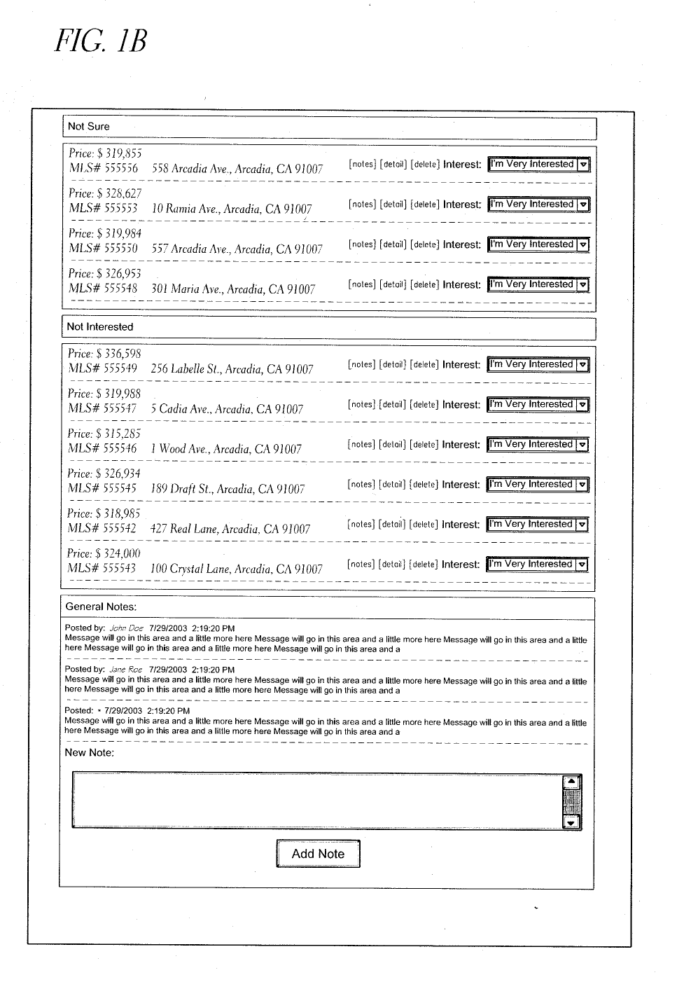

FIG. 1 is a screen capture from a webpage produced by a real estate sales management system. In one embodiment, the management system is a software system that uses JAVA servlets to generate interactive web pages for the agent and the client. The screen capture in FIG. 1 shows a customized webpage produced by the management system for the agent and the client. The screen capture of FIG. 1 shows a list of properties identified by the agent using a Multiple Listing Service (MLS) search for properties that fit the search criteria identified by the client. To generate the list of properties, the agent creates a search using the search criteria identified by the client (e.g., location, price range, size, number of bedrooms, etc.) The agent then directs the management system to run a search using the MLS system. The management system obtains the search results and produces a custom website for the client listing the properties identified in the search.

Using the Internet, the client logs on to the custom website, views the properties identified in the search, and indicates an interest level for each property (e.g., very interested, interested, not sure, not interested, etc.). In one embodiment, the client indicates the interest level while viewing the custom website by using conventional web-based graphical user interface elements such as, for example, drop boxes, buttons, check boxes, web links, etc. In the system shown in FIG. 1, the client indicates an interest level by using a dropdown listbox to select one of either: very interested; interested; not sure; or not interested, etc.

For each property, the client (or agent) can also click a link to a “notes” section or page, a link to a “detail” section or page, and/or a link to a “delete” section or page. Clicking the notes link takes the client or agent to an edit entry control or page that allows the client or agent to enter text notes regarding the property. Clicking the detail link takes the client or agent to a detail page where additional detail is provided about the property (e.g., pictures, listing of features, listing of schools in the area, tax information, etc.). The client or the agent can add notes regarding specific properties. The client or the agent can also add general notes not tied to any specific property (e.g., general communication between the client and the agent).

Once the client has logged onto the custom website and indicated a level of interest for one or more of the properties (and optionally entered notes about the one or more of the properties), the agent can log onto the same custom website and review the client's inputs. The management system maintains a separate custom website for each client, thereby keeping an up-to-date record of the properties for both the agent and the client. On a regular basis, the agent can re-run the MLS search to add new properties to the list as properties come on the market or in response to changing desires of the client.

FIG. 1 shows a screen capture of a page from custom website for a sample agent (John V. Doe) and a sample client (Jane Roe). The screen capture lists 15 properties sorted by the level of interest indicated by the client. A drop-down listbox associated with each property in the list allows the client to specify a level of interest in the property. The level of interest for any property can be changed by the client. A “detail” control for each property allows the client (or agent) to request a display showing additional details about a property. A “notes” control for each property allows the client (or agent) to send a note to the agent (or client) regarding the property. A “delete” control allows the client (or agent) to delete a property from the display.

In FIG. 1, two properties at the top of the list are listed under a “very interested” heading, indicating that the client identified those two properties as being properties in which the client is very interested. In one embodiment, the properties that the client has marked “very interested” include summary information such as, for example, a photograph of the property, number of bedrooms, year built, number of bathrooms, etc.

The next three properties are listed under an “interested” heading, indicating that the client identified those three properties as being properties in which the client is at least interested. The next four properties are listed under a “not sure” heading, indicating that the client identified those two properties as being properties in which the client is not sure of his or her interest level. The last six properties are of the list are listed under a “not interested” heading, indicating that the client identified those six properties as being properties in which the client has no interest.

Each property listing includes the price, MLS number, and address. The property listing for the “very interested” properties also include additional information such as, for example, pictures of the properties, status (e.g., active), size of the structure, size of the lot, number of bedrooms, number of bathrooms, year built, type of structure (e.g., condominium, detached house, etc.). Following the list of properties are notes entered by the agent and the client.

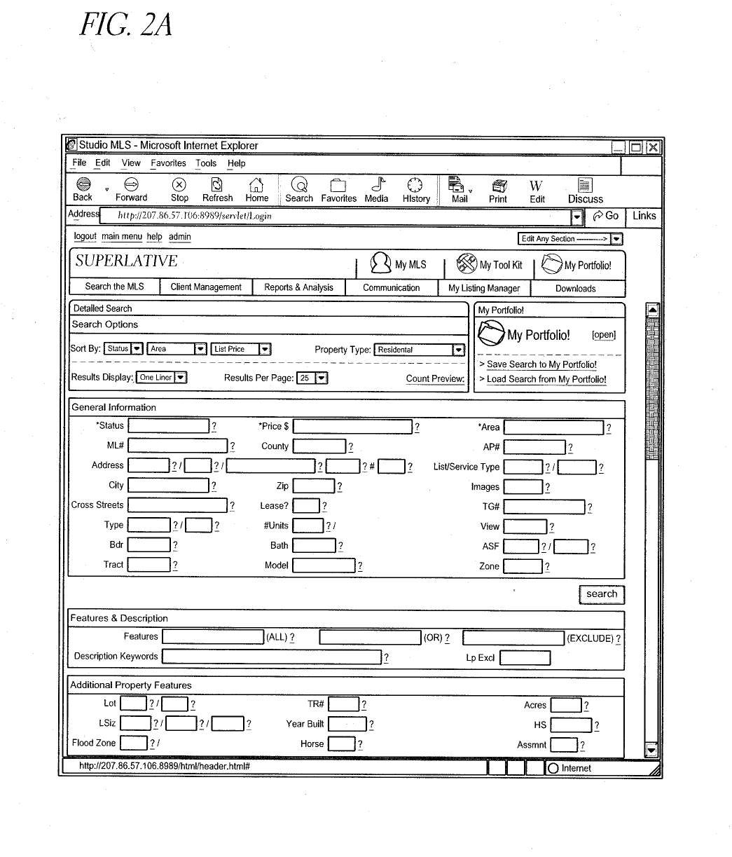

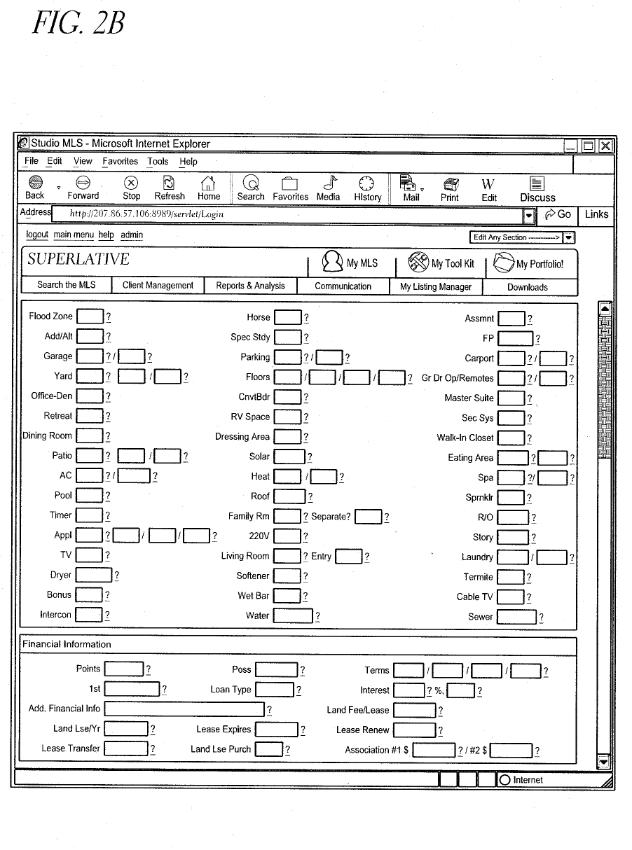

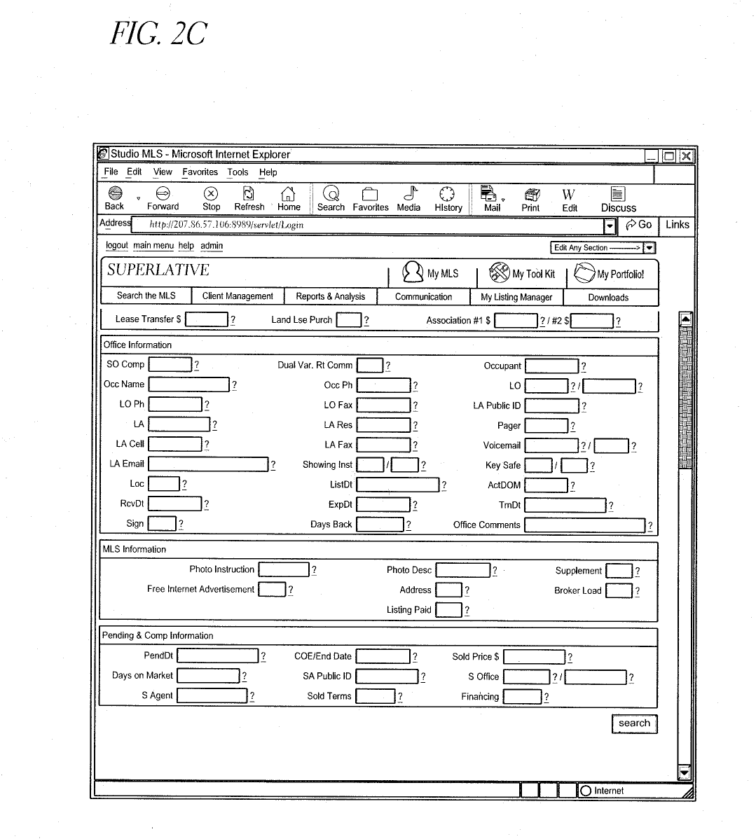

FIG. 2 shows a detailed search construction webpage that the agent can use to construct a customized MLS property search for the client. The agent selects a search profile for each client using MLS search criteria as listed in FIG. 2.

The search criteria include one or more numerical search criteria, such as, for example, price, price range, address, address range, tract, zip code, number of bedrooms, number of baths, year built, zoning, assessments, yard size, lot size, patio size, number of stories, loan points, time to possession, first mortgage amount, second mortgage amount, interest rate, date when lease expires, association fees, etc.

The search criteria can also include one or more selection (e.g., from a list, or yes/no selections) or textual items, such as, for example, county, area, city, builder, tract, model, type of property, zoning (e.g., horses, commercial, mixed residential/commercial, livestock, senior, etc.), assessments, flood zone, parking, garage, car port, office-den, yard, master suite, retreat, RV space, security system, dining room, dressing area, walk-in closet, patio, solar, eating area, air conditioning, heating, spa, pool roof type, sprinkler system, timer, family room, separate family room, appliance hookups, appliances, 220 volt service, TV hookup, living room, entryway, laundry room, dryer, water softener, termite history, bonus room, wet bar, cable TV hookup, intercom, water service, sewer service, etc.

Once the search is constructed, the agent saves the search and the management system can then automatically run the search on a regular basis to identify new properties for the client. In one embodiment, search results are automatically entered into the client's custom webpage, and an email is sent to the client describing the properties identified in the search. The client can then log onto the custom webpage as shown in FIG. 1 and rate the properties. Since the process of running the search and sending the results to the client is automated, an agent is relieved of the burden of updating the search of each of the agent's clients. In one embodiment, the agent is notified (e.g., by email) that the search has been updated, and new results have been sent to the client. The management system also logs search activity and communications activity related to forwarding search results to the client on a communication summary panel as part of the custom webpage. If the agent ignores the notice, or does not receive a notice the agent can simply review the communication summary panel.

The agent can change the search criteria according to the changing desires of the client.

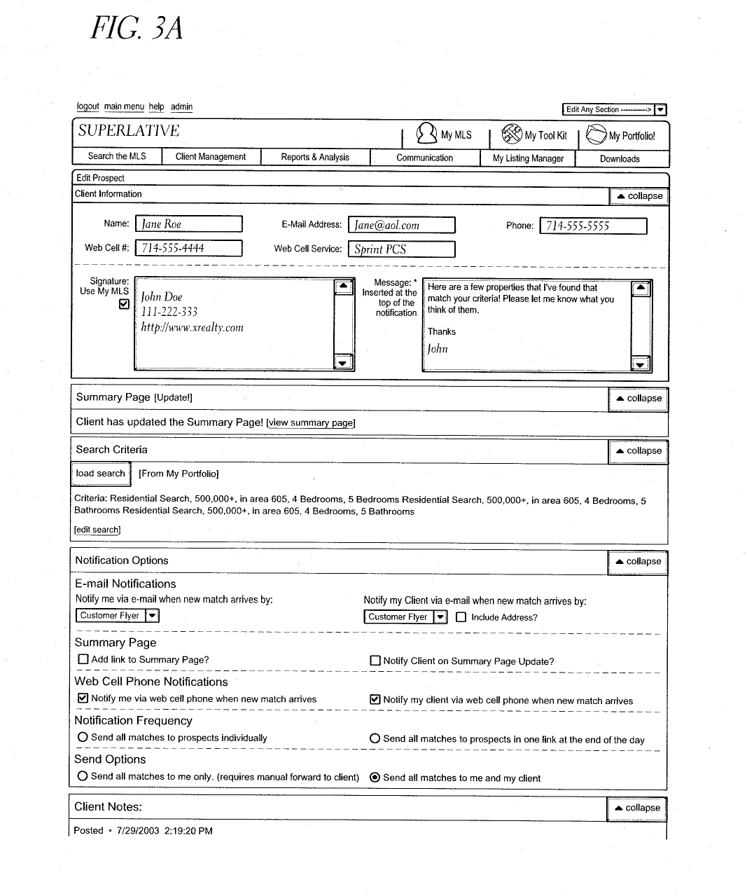

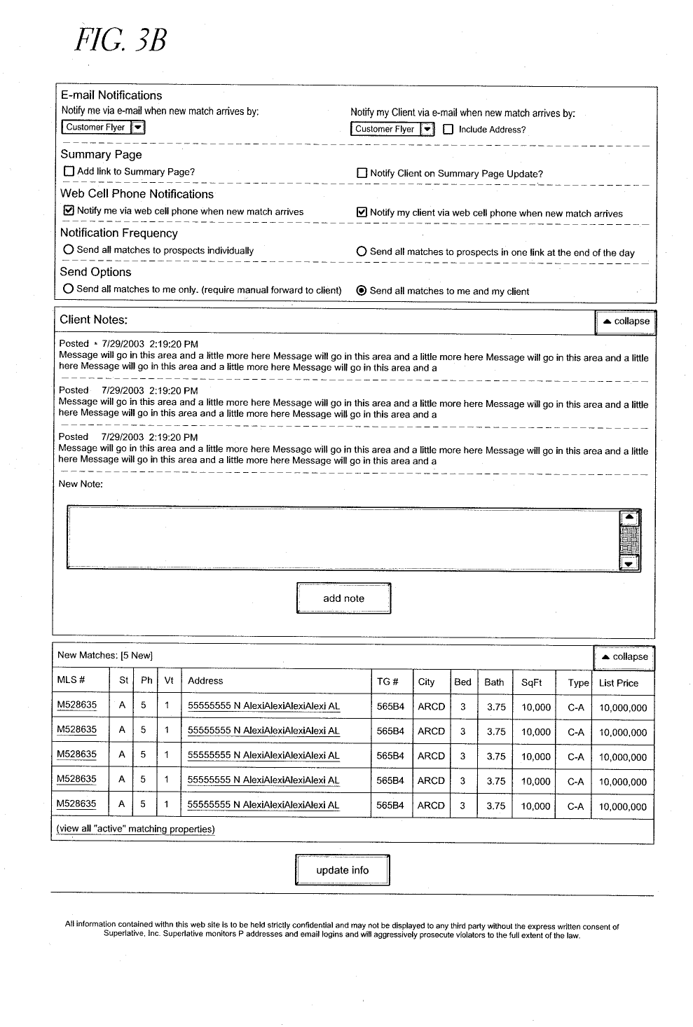

FIG. 3 shows a prospecting screen where the agent can set/modify/delete a client and also create information for each client such as searches, enter contact info, notification settings etc. The agent can also modify the search (e.g., access the search page shown in FIG. 2) by clicking a “search criteria” link in the summary page shown in FIG. 1. The prospecting screen includes a number of notification options including, for example, notifications for the agent and notifications for the client including; notifications by email, web cell phone, etc. The agent can specify that search results can be directed to the agent (and then manually forwarded to the client). Alternatively, the agent can specify that search results be sent to the agent and the client automatically. The agent can specify that the client be notified when the summary page (FIG. 1) is updated.

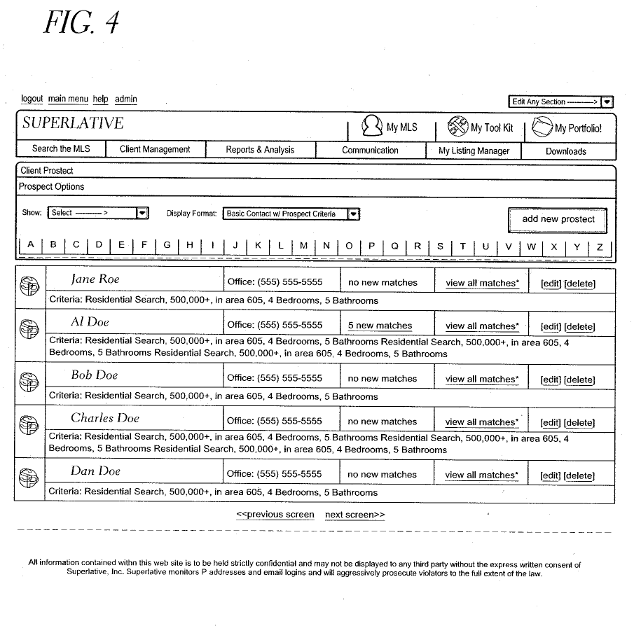

FIG. 4 shows a client list page that provides a client summary list that includes summary information about one or more of the agent's clients. Summary information includes, client name, client telephone number, client's property search criteria, the number of new matches, links to the client's summary page (FIG. 1), etc.

As described above, each time the search identifies new properties, the new properties are presented to the client and the client indicates an interest level in the properties. The management system updates the custom website to list the new properties sorted by level of interest, and the management system list the notes and communication between the agent and the client regarding the properties. The custom website is available to the agent and the client at any time via the Internet, and thus facilitates effective two-way communication between the agent and the client regarding the properties. This is beneficial to both the agent and the client.

Using controls shown in FIG. 4, the agent can request notification when a new mach arrives. The agent can also request that the client be so notified. The agent can request that a link for the property be added to the agent's summary page. The agent can request that a link for the property be added to the client's summary page. The agent can request that the agent and/or the client be notified by cell phone when the search identifies a new property. The agent can request that notifications be sent individually or at the end of the day. The agent can request that new property matches be sent to the agent, who will then review the match and forward the match to the client if appropriate. Alternatively, the agent can request that new property matches be sent to the agent and the client.

The agent's page shown in FIG. 3 shows notes (communication) sent from the client to the agent. The agent's page also includes controls (e.g., an edit field and a button) to allow the agent to send notes to the client. The agent's page also includes a list of matched properties for the client. An agent's page as shown in FIG. 3 is provided for each client of the agent and includes the client's name and contact information (e.g., telephone numbers, email address, etc.)

For the agent, the system organizes the information by client, so that the agent can easily keep track of the type of property desired by each client and the properties considered by each client. In one embodiment, for each client, the system allows the agent to specify an MLS search pattern that fits the type of property desired by the client. In one embodiment, the system automatically re-runs the MLS search on a regular basis and presents new properties identified to the client through the custom website to allow the client to indicate a level of interest.

For the client, the system creates a personalized website that the client can visit at any time to view the new properties located by the search and to review the properties already considered. The system saves time for both that agent and the client, by allowing the client to indicate a level of interest for each property, keeping a record of that interest, keeping a list of the properties considered by the client, and sorting that list according to the client's interest level. The management system also keeps notes entered by the agent or the client for each property, allowing the agent and the client to go back and review the notes at any time.

Although the preceding description contains much specificity, this should not be construed as limiting the scope of the invention, but as merely providing illustrations of embodiments thereof Many other variations are possible within the scope of the present invention. Thus, the scope of the invention is limited only by the claims.

What is claimed is:

1. A method for web-based communication between a real-estate agent and a client, comprising:
constructing a property search profile for a client;
running a property search using the property search profile to generate a list of properties;
notifying the client of said list of properties;
creating a webpage having a list of properties, said webpage including controls to allow the client to specify a level of interest for each property; and
modifying said custom webpage to display said list of properties according to an interest level indicated by the client.

2. The method of claim 1, said custom webpage further comprising a link to allow the client or the agent to enter one or more notes regarding a property.

3. The method of claim 1, further comprising: making said custom webpage available to the agent and the client via the Internet.

4. The method of claim 1, wherein said property search profile includes at least one numeric criteria.

5. The method of claim 1, wherein said property search profile includes at least one selection criteria.

6. The method of claim 1, wherein said property search profile includes at least one numeric criteria selected from the group comprising, price, price range, address, address range, tract, zip code, number of bedrooms, number of baths, year built, zoning, assessments, yard size, lot size, patio size, number of stories, loan points, time to possession, first mortgage amount, second mortgage amount, interest rate, date when lease expires, and association fees.

7. The method of claim 1, wherein said property search profile includes at least one selection criteria selected from the group comprising: county, area, city, builder, tract, model, type of property, zoning (e.g., horses, commercial, mixed residential/commercial, livestock, senior, etc.), assessments, flood zone, parking, garage, car port, office-den, yard, master suite, retreat, RV space, security system, dining room, dressing area, walk-in closet, patio, solar, eating area, air conditioning, heating, spa, pool roof type, sprinkler system, timer, family room, separate family room, appliance hookups, appliances, 220 volt service, TV hookup, living room, entryway, laundry room, dryer, water softener, termite history, bonus room, wet bar, cable TV hookup, intercom, water service, and sewer service.

8. The method of claim 1, wherein a list of selected properties presented to the client is sorted according to said level of interest for each property.

9. The method of claim 1, wherein a list of selected properties presented to the client is configured such that list items corresponding to properties of relatively higher interest include a photograph.

10. The method of claim 1, wherein a list of selected properties presented to the client is configured such that list items corresponding to properties of relatively lower interest include an address.

11. The method of claim 1, wherein a list of selected properties presented to the client is configured such that list items corresponding to properties of relatively higher interest include a summary.

12. The method of claim 1, wherein a list of selected properties presented to the client is configured such that list items corresponding to properties of relatively higher interest include a summary comprising number of bedrooms, price, and home size.

13. The method of claim 1, said webpage further comprising a control to allow the client to send a message to the agent.

14. The method of claim 1, further comprising constructing a webpage having input controls to allow the agent to construct said property search profile.

15. The method of claim 1, further comprising saving said property search profile.

16. The method of claim 1, further comprising automatically running said property search at specified intervals.

17. The method of claim 1, further comprising constructing a webpage comprising a client summary list showing summary information for the client.

18. The method of claim 17, wherein said client summary list further comprises summary information for other clients.

19. The method of claim 17, wherein said summary information comprises an indication that said property search has identified new properties for the client.

20. The method of claim 17, wherein said summary information comprises a summary of said search criteria.

21. The method of claim 1, said webpage further comprising a control to allow the agent to send a message to the client.

22. The method of claim 1, said webpage further comprising a display showing one or more communications between the agent and the client.

23. The method of claim 1, said webpage further comprising a control to allow the client to request additional details about each of one or more properties.
